(19) United States
(12) Patent Application Publication
(10) Pub. No.: US 2023/0316434 A1
(43) Pub. Date: Oct. 5, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Toyokazu NAKASHIMA, Nagoya-shi (JP); Shunsuke SAGARA, Nisshin-shi (JP); Naoya OKA, Nagakute-shi (JP)

(21) Appl. No.: 18/157,893

(22) Filed: Jan. 23, 2023

(30) Foreign Application Priority Data
Mar. 8, 2022 (JP) 2022-035327

(51) Int. Cl. G06Q 50/06; G06F 16/2455

(52) U.S. Cl. CPC G06Q 50/06; G06F 16/2455

(57) ABSTRACT

An information processing device according to an aspect of the present disclosure receives a request for a product search from a user terminal, and extracts product information of a product corresponding to the received request from a product database. The product information includes emission information indicating an emission amount of a greenhouse gas of the product in association with a production site of the product. Then, the information processing device returns the extracted product information to the user terminal so that the emission information can be output in association with the production site.

### CROSS-REFERENCE TO RELATED APPLICATION

This application claims priority to Japanese Patent Application No. 2022-035327 filed on Mar. 8, 2022, incorporated herein by reference in its entirety.

### BACKGROUND

### 1. Technical Field

The present disclosure relates to an information processing device, an information processing method, and a storage medium storing a program for providing product information.

### 2. Description of Related Art

Japanese Unexamined Patent Application Publication No. 2010-044667 (JP 2010-044667 A) proposes a system for providing an emission amount of greenhouse gas generated by consumption of a product. Specifically, in the system proposed in JP 2010-044667 A, a management server includes a database that stores a correspondence relationship between a cooking method of a product and an emission amount of greenhouse gas when the product is cooked by the cooking method. The management server receives, via a communication network, a request to provide the emission amount of the greenhouse gas related to consumption of each product belonging to a product group listed in a product catalog. The management server derives, based on the database and the cooking method, the emission amount of the greenhouse gas related to consumption of each of the products belonging to the predetermined product group. The management server then provides the derived emission amount via the communication network.

### SUMMARY

The present disclosure provides a technique for visualizing at least a part of factors contributing to a reduction of greenhouse gas emissions achieved by actions to select products.

An information processing device according to a first aspect of the present disclosure includes a control unit configured to: receive a request for a product search from a user terminal; extract product information of a product corresponding to the received request from a product database, the product information including emission information indicating an emission amount of greenhouse gas of the product in association with a production site of the product; and return the extracted product information to the user terminal such that an output of the emission information in association with the production site is allowed.

An information processing method according to a second aspect of the present disclosure is an information processing method executed by a computer. The information processing method includes: receiving a request for a product search from a user terminal; extracting product information of a product corresponding to the received request from a product database, the product information including emission information indicating an emission amount of greenhouse gas of the product in association with a production site of the product; and returning the extracted product information to the user terminal such that an output of the emission information in association with the production site is allowed.

A storing medium according to a third aspect of the present disclosure stores a program that is a program for causing a computer to execute an information processing method. The information processing method includes: receiving a request for a product search from a user terminal; extracting product information of a product corresponding to the received request from a product database, the product information including emission information indicating an emission amount of greenhouse gas of the product in association with a production site of the product; and returning the extracted product information to the user terminal such that an output of the emission information in association with the production site is allowed.

According to the present disclosure, it is possible to visualize at least a part of factors of a reduction of the greenhouse gas emissions achieved by actions to select products.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example of a scene to which the present disclosure is applied;

FIG. 2 schematically illustrates an example of a hardware configuration of the information processing device according to the embodiment;

FIG. 3 schematically illustrates an example of a software configuration of the information processing device according to the embodiment;

FIG. 4 schematically illustrates an example of a product database according to an embodiment;

FIG. 5 schematically illustrates an example of a user database according to an embodiment;

FIG. 6 is a flowchart illustrating an example of a processing procedure of the information processing device according to the embodiment;

FIG. 7 schematically illustrates an example of a screen display of product information according to the embodiment;

FIG. 8 schematically illustrates an exemplary screen-display of product information according to the embodiment; and

FIG. 9 schematically illustrates an example of a product database according to a modification.

### DETAILED DESCRIPTION OF EMBODIMENTS

According to the conventional system such as JP 2010-044667 A, it is possible to provide information indicating the emission amount of the greenhouse gas for each product. The user compares the emission amount of greenhouse gas for each product by referring to the information provided. The user can contribute to a reduction in the amount of greenhouse gas emissions by selecting a product with a low emission amount of greenhouse gas.

However, conventional systems only provide information indicative of emission amount of greenhouse gas in association with products. That is, even if the user can select a product with a low emission amount, the user is opaque about the factor of the low emission amount of the greenhouse gas in the product. That is, in the conventional system, the factor of the reduction of the greenhouse gas emission by the selection action of the product has not been visualized. Further, it takes time and effort for the user to confirm the cause.

On the other hand, the information processing device according to the first aspect of the present disclosure includes a control unit. The control unit receives a request for a product search from the user terminal. The control unit extracts the product information of the product corresponding to the received request from the product database. The product information includes emission information indicating the emission amount of greenhouse gas of the product in association with the production site of the product. The control unit returns the extracted product information to the user terminal so that the emission information can be output in association with the production site.

In the information processing device according to the first aspect of the present disclosure, information indicating an emission amount of a greenhouse gas of a product is provided in association with a production site. As a result, the user can compare the emission amounts of the greenhouse gases between the production sites of the respective commodities. In this comparison, since the emission amounts of the greenhouse gas of the target product are smaller than those of other commodities of the same type, the user can identify one of the factors that reduce the greenhouse gas emissions of the target product. That is, the user can specify that the production at the target production site is one of the factors for reducing the emission amount of the greenhouse gas in the target product. Therefore, according to the information processing device according to the first aspect of the present disclosure, it is possible to visualize at least a portion of the factors of reduction in greenhouse gas emissions due to the choice behavior of products. As a result, it is possible to reduce the time and effort for the user to confirm the cause.

Hereinafter, an embodiment according to an aspect of the present disclosure (hereinafter, also referred to as “present embodiment”) will be described with reference to the drawings. However, the embodiments described below are merely examples of the present disclosure in all respects. Various modifications or variations may be made without departing from the scope of the present disclosure. In the implementation of the present disclosure, a specific configuration according to the embodiment may be adopted as appropriate. Although the data appearing in the present embodiment is described in a natural language, more specifically, the data is designated by a pseudo language, a command, a parameter, a machine language, or the like that can be recognized by a computer.

### 1 Application Example

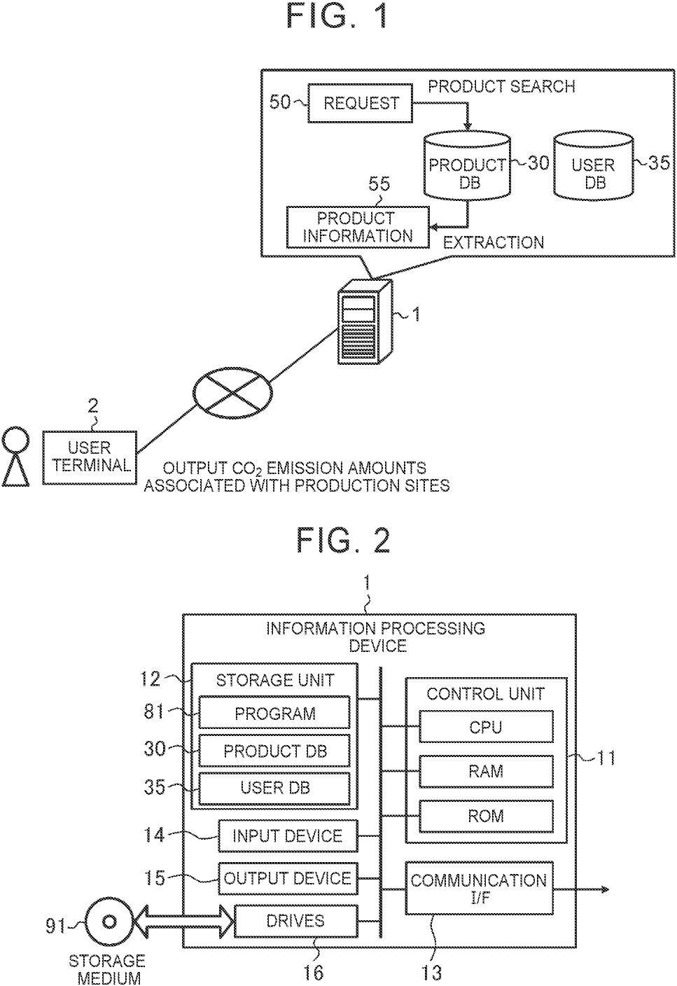

FIG. 1 schematically illustrates an example of a scene to which the present disclosure is applied. The information processing device 1 according to the present embodiment is one or more computers. The computer is configured to execute information processing for providing product information in response to a request from a user.

Specifically, the information processing device 1 according to the present embodiment receives the product search request 50 from the user terminal 2. The information processing device 1 extracts the product information 55 of the product corresponding to the received request 50 from the product database 30. The product information 55 is configured to include emission information indicating an emission amount of the greenhouse gas of the product in association with a production site of the product. The information processing device 1 returns the extracted product information to the user so that the emission information can be output in association with the production site. The output of the emission information in association with the production site may be configured by outputting the emission amount of the greenhouse gas of the product in association with the production site.

As described above, according to the present embodiment, it is possible to provide information (emission information) indicating the emission amount of the greenhouse gas of the product in association with the production site that produces the product. As a result, the user can compare the emission amounts of the greenhouse gases between the production sites of the respective products. In this comparison, when the emission amount of greenhouse gas of the target product is smaller than that of other products of the same type, the user can specify that the production at the target production site is one of the factors for reducing the amount of greenhouse gas emissions of the target product. Therefore, according to this embodiment, it is possible to visualize at least a portion of the factors of the reduction of greenhouse gas emissions by the choice behavior of products. As a result, it is possible to reduce the time and effort for the user to confirm the cause.

### Production Site

A product is an article that may be the subject of a business. The product may be any product, such as, for example, food and drink, appliances, etc. The number of articles to be treated as a product is not particularly limited, and may be appropriately determined according to the embodiment. As an example, suppose a case where 24 water-filled PET bottles are sold together. In this case, in one example, 24 water-filled PET bottles may be considered as a single product. In another example, a single water-filled PET bottle may be considered as a single product. In other words, the 24 water-filled PET bottles may be regarded as 24 products.

The production site is a base for producing products. The production site of each product may be appropriately determined according to the embodiment. The production site may be, for example, various factories, a cooking facility, a procurement facility, or the like. The goods may be produced at a single production site or at a plurality of production sites. Production of goods at a plurality of production sites may include production of goods at each production site. Production of a product at a plurality of production sites may include production of some components of the product and other components at separate production sites. Note that the component of the product is an article constituting at least a part of the product. The unit of the component may be appropriately determined according to the embodiment. The component may be an article that can be grasped by itself. As an example, if the product is water enclosed in a labeled PET bottle container, the components of the product may be water, PET bottle containers, and labels. Components of the product may include packaging materials.

In an example, outputting the emission information in association with the production site may be configured by outputting the emission amount of the greenhouse gas of the product in the single production site when the product is produced in the single production site. In an example, outputting the emission information in association with the production site may be configured by outputting a statistical amount of the emission amount of the greenhouse gas of the product in each of the plurality of production sites when the product is produced in the plurality of production sites. The type of the statistical amount is not particularly limited as long as it can express the characteristics of the emission amount of the greenhouse gas of the product at each of the plurality of production sites, and may be appropriately selected according to the embodiment. When the product is produced independently at each production site, the statistical amount may be, for example, an average value (simple average, weighted average), a maximum value, a minimum value, a percentile value, or the like. When some components of a product and other components are produced at different production sites (i.e., one product is produced through multiple production sites), the statistical amount may be, for example, a total value or the like. A case in which some components and other components are produced at different production sites is a case in which, for example, production of PET bottle containers and procurement of water are carried out at different sites when the product is water enclosed in a labeled PET bottle container.

As a typical example, if the products are produced independently at each production site and the number of products produced is equal at each production site, a simple average may be adopted for the statistical amount. As another example, in a case where there is a bias in the number of products produced at each production site, a weighted average corresponding to a ratio of the number of products produced at each production site may be adopted as the statistical amount. As yet another example, in a case where the components of the product are produced at different production sites, the total value of the emission amounts of the greenhouse gases for the products (components) at the respective production sites may be adopted as the statistical amount. In this case, the emission amount of the greenhouse gas of the product may include the greenhouse gas emission amount at the time of transporting the components elements between the production sites. When the same component is produced at multiple production sites, the average value (simple average, weighted average) of the emission amount of the greenhouse gas or the products (components) at each production site may be adopted as the greenhouse gas emissions of the component.

However, the output form in the case where products are produced at a plurality of production sites may not be limited to such an example. In another example, when the product is produced at a plurality of production sites, outputting the emission information in association with the production sites may be configured by individually outputting the emission amount of the greenhouse gas of the product for each production site.

### Request

The request 50 (query) includes a condition for searching for a product. The search conditions may be specified in any manner, including known ways. As an example, the search condition may be specified by a character string (for example, a product name, a content, or the like), a category, an attribute (for example, a price range, a size, a color scheme, a material, a brand, an evaluation value, or the like), or the like. The information processing device 1 refers to the product database 30. The information processing device 1 is configured to extract the product information 55 of the product corresponding to the condition specified by the request 50. Any method including a known method may be employed as the configuration and search method of the product database 30.

### Greenhouse Gas

As a typical example, the greenhouse gas is carbon dioxide. In addition, the greenhouse gas may include a greenhouse gas such as methane, dinitrogen monoxide, fluorocarbons, sulfur hexafluoride, and sulfur trifluoride. As shown in FIG. 1, in the present embodiment, carbon dioxide is adopted as an example of a greenhouse gas for convenience of explanation. However, the greenhouse gas of which emission amount is to be output may not be limited to carbon dioxide, and may be appropriately selected according to the embodiment. The greenhouse gas of which emission amount is to be output may be composed of one or more kinds of gases. In one example, the greenhouse gas of interest may be comprised of carbon dioxide, methane, dinitrogen monoxide, fluorocarbons, sulfur hexafluoride, sulfur trifluoride, or combinations thereof.

The emission amounts of greenhouse gases of products at production sites may be measured as appropriate according to the embodiment. In an example, the emission amount of greenhouse gas of a product at a production site may be obtained by measuring the amount of greenhouse gas emitted in a process of producing a product such as operation, cooking, and procurement of a factory.

### Product Information

The product information stored in the product database 30 includes emission information indicating the emission amount of the greenhouse gas in association with the production site. The data format and configuration of the product information stored in the product database 30 are not particularly limited, and may be appropriately determined according to the embodiment. The product information may include information such as a description of a product, a price, a product image, and the like in addition to the emission information.

In the user terminal 2, the extracted product information 55 of each product may be output in any format including, for example, a list format, a table format, and other known formats. Further, the output of the product information 55 including the emission information may be executed in any format including, for example, a known format such as an image display or an audio output. Emission information includes emission amounts of greenhouse gases associated with production sites. The data format and configuration of the emission information are not particularly limited, and may be appropriately determined according to the embodiment.

### Sites That Use Renewable Energy

The production site of the product may include a first type site utilizing renewable energy. The renewable energy used in the production site of the first type is not particularly limited, and may be appropriately selected according to the embodiment. The renewable energy may be, for example, energy obtained from solar, wind, hydro, geothermal, solar, atmospheric heat, other naturally occurring heat, biomass, etc.

On the other hand, in the present embodiment, a production site that does not use renewable energy is defined as a second type site. The second type site does not use renewable energy (e.g., utilizes energy such as thermal power generation). The second type site is a production site capable of recycling the same products as the first type site. The second type site may be virtually set corresponding to the first type site.

When the production site of the product includes the first type site, the emission information of the product may include comparison information. The comparison information indicates a difference between the first emission amount and the second emission amount. The first emission amount is the amount of greenhouse gas emissions of the product when the product is produced at the first type site. The second emission amount is the emission amount of the greenhouse gas of the product when the product is produced at the second type site. Outputting the emission information may include outputting the comparison information.

This makes it possible to visualize the contribution to the reduction of the emission amount of greenhouse gas by selecting products produced by production sites that use renewable energy. In addition, depending on the characteristics of the energy supply in each region, it is possible to visualize the effect of reducing the emission amount of greenhouse gas caused by the production of products at production sites that use renewable energy.

As an example, in areas with high levels of nuclear power generation, emissions of greenhouse gases from power generation are relatively low. Therefore, the effect of reducing the emission amount of greenhouse gas by producing products at the first type site is small. In contrast, greenhouse gas emissions from power generation are relatively high in regions where thermal power generation is common. Therefore, the reduction effect of the emission amount of greenhouse gas by the production of products at the first type site is large. Therefore, the output of the comparison information makes it possible to visualize that the emission amount of the greenhouse gas can be greatly reduced by producing products at the first type site in regions where thermal power is generated more than in regions where nuclear power is generated.

The comparison information allows the user to grasp the difference in the emission amount of the greenhouse gas in the case where the product is produced at the first type site and the case where the product is produced at the second type site. The data format of the comparison information is not particularly limited, and may be appropriately determined according to the embodiment. In an example, the comparison information may be configured by information indicating the emission amount of greenhouse gas of the product, and the amount of reduction in greenhouse gas emissions caused by the production of the product at the first type site, instead of the second type site. In another example, the comparison information may be configured by information indicating an emission amount of the greenhouse gas of the product and an emission amount of the greenhouse gas of the product when the product is produced at the second type site.

By outputting the comparison information, the user can grasp the difference in the emission amount of the greenhouse gas in the case where the product is produced at the first type site and in the case where the product is produced at the second type site. The form of output of the comparison information is not particularly limited, and may be appropriately determined according to the embodiment. In one example, outputting the comparison information may be configured by outputting the emission amount of greenhouse gas of the product and the amount of reduction in greenhouse gas emissions due to production at the first type site. In another example, outputting the comparison information may be configured by outputting the emission amount of greenhouse gas of the product when the product is produced at the first type site and when the product is produced at the second type site. In a case where any example of the above-described data format of the comparison information is adopted, an example of any output form may be adopted.

### Greenhouse Gas Emissions in Transportation

In a typical e-commerce transaction, purchased products are transported to a user-specified address. Correspondingly, in the present embodiment, an estimate of the emission amount of the greenhouse gas in the transportation from the production site to the address designated by the user may be calculated. Then, outputting the emission information in association with the production site may include outputting an estimated result of the emission amount of the greenhouse gas in the transportation.

That is, in the present embodiment, the product information 55 may further include information indicating the location of the production site. Then, outputting the emission information in association with the production site may include outputting the emission amount of the greenhouse gas in the transportation of the product from the production site to the address designated by the user. The emission amounts of greenhouse gases in the transport of goods from production sites to user-specified addresses are derived by derivation rules associated with the goods. This makes it possible to visualize the emission amount of the greenhouse gas in the transportation of the product from the production site to the address designated by the user.

The address to be transported may be appropriately designated by the user. The user-specified address may be, for example, an address of the user himself or herself, an address of a recipient who gives the product, or the like. The method of specifying the address is not particularly limited, and may be appropriately selected according to the embodiment. In an example, the address to be transported may be designated by an input in the user terminal 2. In another example, the user-specified address may be obtained from the user database 35.

In the user database 35, one or more addresses that may be designated by the user may be registered in advance in association with the user. That is, the user database 35 may hold address information in association with identification information of the user. The user-specified address may be selected from one or more addresses registered in the user database 35 in association with the user’s identification information.

The transport path may be appropriately determined according to the embodiment. In one example, the merchandise may be transported directly from the production site to a user-specified address. In another example, the merchandise may be transported from the production site via one or more waypoints to a user-specified address. The waypoint may be, for example, a storage location (such as a warehouse).

The emission amounts of greenhouse gases in transportation are the amount of greenhouse gases emitted by transportation of products. The products may be transported by any means. The means of transportation of the products may be, for example, a transportation vehicle (such as a truck), a railway, an aircraft, a drone, etc. In one example, the emission amounts of greenhouse gases in transportation may be estimated from the energy consumed in transportation by a given vehicle according to the product.

If the derivation rule is associated with a product, the storage destination and the data format thereof are not particularly limited, and may be appropriately determined according to the embodiment. In one example, the derivation rules may be stored in the product database 30 along with the product information. In another example, the derivation rule may be stored in a storage area different from the product database 30.

The derivation rule may be appropriately specified for each product so that the emission amount of greenhouse gas in transportation can be calculated. As an example, the derivation rule may be configured by a formula of “ax+b”. “x” denotes the transport distance and “a” and “b” denote constants. The values of “a” and “b” may be arbitrarily specified. The value of “a” may be determined, for example, depending on the vehicle, the energy used in the vehicle, etc. The value of “b” may be determined according to, for example, the emission amount of greenhouse gas in transportation from the production site to the warehouse.

In an example, when the derivation rule is adopted, a route of transportation from a production site to a designated address may be searched on a map. The search for the transport route may be performed by any map search method including a known method. In a case where the product is stored in a warehouse away from the production site, a transportation route from the warehouse to a designated address may be searched. Then, the transport distance may be calculated from the searched route. By substituting the calculated value of the transportation distance into the above calculation formula and performing the calculation of the calculation formula, the emission amount of the greenhouse gas in the transportation to the address designated by the user may be derived.

In a typical example, the process of deriving the emission amount according to the derivation rule may be executed by the information processing device 1. However, the present embodiment is not limited to such an example. In another example, the information indicating the derivation rule may be provided to the user terminal 2 together with the product information. Thus, the process of deriving the emission amount according to the derivation rule may be executed by the user terminal 2.

Further, in the present embodiment, outputting the emission information in association with the production site may further include outputting an outline of the location of the production site. The outline of the location is information indicating an approximate location obtained by partially omitting the location (address). The range of locations to be output as an outline may be appropriately determined according to the embodiment so that the approximate location can be grasped. As an example, outputting the outline of the location may be outputting a part of the location (for example, up to the prefectural name) by omitting a small section (for example, an address) among a plurality of sections constituting the location (address).

Further, in the present embodiment, outputting the emission information in association with the production site may further include outputting information indicating whether the location of the production site is domestic or overseas. Hereinafter, for convenience of explanation, information indicating whether the location of the production site is domestic or overseas is also referred to as “location country information”. Whether the location of the production site is domestic or overseas may be determined by an arbitrary criterion. In an example, whether the location of the production site is domestic or overseas may be determined based on a main region in which the information processing device 1 provides the product information. In this case, it may be determined in advance whether the location of the production site of each product is domestic or overseas. In another example, whether the location of the production site is domestic or overseas may be determined based on the location of the user of the user terminal 2 (for example, an address designated by the user, an access location of the user terminal 2, and the like).

The output of the location country information is not particularly limited as long as it is possible to grasp whether the location of the production site of the target product is domestic or overseas, and may be appropriately determined according to the embodiment. In an example, outputting the location country information may be configured by outputting a character string (for example, “domestic production”, “overseas production”, or the like) indicating whether the local production or the overseas production is performed. In another example, outputting the location country information may be configured by outputting an arbitrary indicator indicating whether domestic production or overseas production. In yet another example, outputting the location country information may be configured by outputting the location (address) of the production site in a state in which the country name in which the production site exists can be identified.

By outputting an outline of the location of the production site and at least one of the countries, emission amounts of greenhouse gases in transport can be visualized in relation to the location of the production site. This makes it possible to visualize the efforts of product providers to reduce greenhouse gas emissions in transportation. For example, despite the fact that production sites are located far away (production sites are located overseas), emission amounts of greenhouse gases in transportation may be low. In this case, it is visualized that the efforts of the product provider have reduced the emission of greenhouse gases in transportation.

As a comparison object, an emission amount of the greenhouse gas in the transportation of another product produced at another production site that is the same as or in the vicinity of the production site of the target product may be output. That is, outputting the emission information in association with the production site may include outputting, together with the emission amount of the greenhouse gas in the transportation of the product, the emission amount of the greenhouse gas in the transportation of the other product produced in another production site that is the same as or in the vicinity of the production site of the product.

In one example, the emission amount of greenhouse gas in the transportation of other products may be derived from the product information of the other products registered in the product database 30 in the same manner as described above. If there are more than one other product, the emission amount of greenhouse gases in the transport of the other product may be represented by statistical amount such as, for example, mean, maximum, percentile, etc. In another example, emission amounts of greenhouse gases in the transport of other products may be expressed by a reference value of emission amounts of greenhouse gases in normal transport. The standard value of the emission amount may be calculated as appropriate assuming a general transportation means. Further, the reference value of the emission amount may be appropriately managed in association with the product. As an example of the management, the reference value of the emission amount may be stored in the product database 30 together with the product information. In this case, the reference value of the emission amount may be acquired from the product database 30.

In addition, the same or neighboring ranges may be appropriately determined according to the embodiment. In an example, as the range of the same or neighborhood, a range of the same level of the emission amount of greenhouse gas may be appropriately set as long as the same transportation means is used, such as when the production site of the target product and the production site of the other product exist in the same city, exist in the same prefecture, or the like.

### User Terminal

The user terminal 2 is one or more computers used by the user. The user terminal 2 may be a desktop Personal Computer (PC, a mobile telephone including a smart phone, a tablet PC, a general-purpose computer, or the like, in addition to a computer specifically designed for a provided service.

As illustrated in FIG. 1, the information processing device 1 and the user terminal 2 may be connected to each other via a network. The type of network may be selected from among, for example, the Internet, wireless communications networks, mobile communications networks, telephone networks, dedicated networks, etc., as appropriate. Any method including a known method may be adopted for data communication between the information processing device 1 and the user terminal 2.

### Two Configuration Examples

### Example of the Hardware Configuration

FIG. 2 schematically illustrates an example of a hardware configuration of the information processing device 1 according to the present embodiment. As illustrated in FIG. 2, the information processing device 1 according to the present embodiment is a computer in which the control unit 11, the storage unit 12, the communication interface 13, the input device 14, the output device 15, and the drive 16 are electrically connected to each other.

The control unit 11 includes a hardware processor such as Central Processing Unit (CPU), Random Access Memory (RAM), Read Only Memory (ROM), and the like, and is configured to execute information processing based on programs and various types of data. The control unit 11(CPU) is an exemplary processor resource.

The storage unit 12 includes, for example, a hard disk drive, a solid state drive, and the like. The storage unit 12 is an example of a memory resource. In the present embodiment, the storage unit 12 stores various types of information such as the program 81, the product database 30, and the user database 35.

The program 81 is a program for causing the information processing device 1 to execute information processing (FIG. 6 described later) for providing product information in response to a request from a user. The program 81 includes a series of instructions for the information processing. The product database 30 stores product information in a searchable format. In addition, the user database 35 stores user information including one or more addresses that can serve as transportation destinations of products in a searchable format.

The communication interface 13 is, for example, a wired Local Area Network (LAN) module, a wireless LAN module, or the like, and is an interface for performing wired or wireless communication via a network. The information processing device 1 can perform data communication with another computer (for example, the user terminal 2) using the communication interface 13.

The input device 14 is, for example, a device for inputting a mouse, a keyboard, or the like. The output device 15 is, for example, a device for outputting a display, a speaker, or the like. The operator can operate the information processing device 1 by using the input device 14 and the output device 15. The input device 14 and the output device 15 may be integrally formed of, for example, a touch panel display.

The drive 16 is a device for reading various kinds of information such as a program stored in the storage medium 91. At least one of the program 81, the product database 30, and the user database 35 may be stored in the storage medium 91. The storage medium 91 is a medium for storing information such as a program so that a computer, other devices, a machine, or the like can read various kinds of information such as a stored program. The storage medium 91 stores information such as the program by electrical, magnetic, optical, mechanical, or chemical action. The information processing device 1 may acquire at least one of the program 81, the product database 30, and the user database 35 from the storage medium 91.

FIG. 2 illustrates a disk-type storage medium such as a CD, DVD as an exemplary storage medium 91. However, the type of the storage medium 91 is not limited to the disk type, and may be other than the disk type. As a storage medium other than the disk type, for example, a semiconductor memory such as a flash memory can be exemplified. The type of the drive 16 may be appropriately selected according to the type of the storage medium 91.

Regarding the specific hardware configuration of the information processing device 1, it is possible to omit, replace, and add components as appropriate depending on the embodiment. For example, the control unit 11 may include a plurality of hardware processors. Hardware processors may be comprised of microprocessors, field-programmable gate array (FPGA), Graphics Processing Unit (GPU), etc. At least one of the communication interface 13, the input device 14, the output device 15, and the drive 16 may be omitted.

The information processing device 1 may further include an external interface for connecting to an external device. The external interfaces are, for example, Universal Serial Bus (USB) ports, dedicated ports, and the like. The type and number of external interfaces may be appropriately determined according to the type and number of external devices to be connected. The information processing device 1 may be connected to another computer via an external interface. The information processing device 1 may be connected to an external storage device via an external interface. In this case, at least one of the program 81, the product database 30, and the user database 35 may be stored in an external storage device. The information processing device 1 may acquire at least one of the program 81, the product database 30, and the user database 35 from an external storage device.

The information processing device 1 may include a plurality of computers. In this case, the hardware configurations of the computers may or may not be identical. The information processing device 1 may be configured by any computer capable of executing information processing. The information processing device 1 may be a general-purpose server device, a general-purpose PC, or the like, in addition to a computer designed exclusively for a service to be provided.

### Software Configuration Example

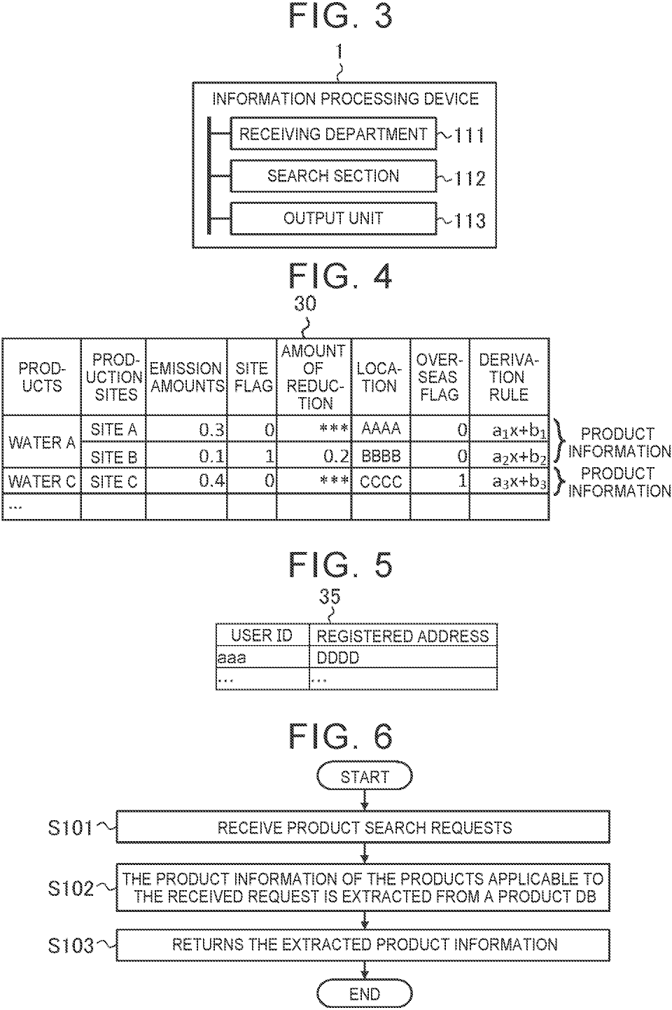

FIG. 3 schematically illustrates an example of a software configuration of the information processing device 1 according to the present embodiment. The control unit 11 of the information processing device 1 develops the program 81 stored in the storage unit 12 into a RAM. Then, the control unit 11 executes the instruction included in the program 81 loaded in RAM by CPU. Thus, as illustrated in FIG. 3, the information processing device 1 according to the present embodiment operates as a computer including the receiving unit 111, the search unit 112, and the output unit 113 as software modules. That is, in the present embodiment, the software modules of the information processing device 1 are realized by the control unit 11(CPU).

The receiving unit 111 is configured to receive the product search request 50 from the user terminal 2. The search unit 112 is configured to extract the product information 55 of the product corresponding to the received request 50 from the product database 30. The product information 55 includes emission information indicating an emission amount of the greenhouse gas of the product in association with a production site of the product. The output unit 113 is configured to return the extracted product information 55 to the user terminal 2 so that the emission information can be output in association with the production site.

In the present embodiment, the software modules of the information processing device 1 are all realized by a general-purpose CPU. However, some or all of the software modules may be implemented by one or more dedicated processors. Each of the above modules may be implemented as a hardware module. Regarding the software configuration of the information processing device 1, modules may be omitted, replaced, and added as appropriate depending on the embodiment.

### Product Database

FIG. 4 schematically illustrates an example of the product database 30 according to the present embodiment. In the example of FIG. 4, the product database 30 has a data structure in a table format. The product data illustrated in FIG. 4 corresponds to the product information of two commodities. The product data includes fields for storing a product name, a production site, an emission amount, a site flag, a reduction amount, a location, an overseas flag, and a derivation rule.

In the product name field, information indicating the name of the product is stored. In the production site field, information indicating the name of the production site is stored. In the emission amount field, information indicating the emission amount of the greenhouse gas of the target product at the target production site is stored.

In the site flag field, information (flag) indicating whether or not the target production site is a first type site using renewable energy is stored. In the example of FIG. 4, “1” indicates that the target production site is the first type site. “0” indicates that the target production site is a second type site that does not use renewable energy. The Reduction Amount field stores information indicating the amount of reduction in greenhouse gas emissions caused by the production of products at the first type site, not the second type site.

In the location field, information indicating the location of the production site is stored. In the overseas flag field, information (flag) indicating whether the location of the production site is domestic or overseas is stored. In the example of FIG. 4, “0” indicates that the production site is located in the country. “1” indicates that the production site is located overseas.

In the example of FIG. 4, records (row data) are provided for fields after the production site according to each production site. In each record, various kinds of information of each production site are stored. The information stored in each field from the emission amount to the overseas flag is an example of the emission information.

The information stored in the emission amount field and the reduction amount field is an example of the comparison information. That is, in the example of FIG. 4, the comparison information includes information indicating the emission amount of greenhouse gas of the product and the amount of reduction in greenhouse gas emissions caused by the production of the product at the first type site instead of the second type site.

The information stored in the location field is an example of information indicating the location of the production site. The information stored in the overseas flag field is an example of information indicating whether the location of the production site is domestic or overseas. When the location information stored in the location field includes information capable of specifying a country name or a country name, it is possible to determine whether the location of the production site is domestic or overseas from the location information. Therefore, the information stored in the location field may be treated as an example of information indicating whether the location of the production site is domestic or overseas. In a case where the country where the production site is located is determined from the location information, the overseas flag field may be omitted.

In the example of FIG. 4, the following conditions are assumed as a specific example of the product. In other words, the product “Water A” is produced at two production sites (“Site A” and “Site B”), and the product “Water C” is produced at a single production site (“Site C”). Of the two production sites that produce Water A, “site A” is the second type site, and “site B” is the first type site. Site C, which produces Water C, is the second type site. The two production sites that produce “Water A” (“site A” and “site B”) exist domestically, and “site C” that produces “Water C” exists overseas. Derivation rules are provided for each production site of the product. However, these conditions are merely specific examples for convenience of explanation, and do not limit the contents of the present disclosure.

Note that the data format of the product database 30 is not limited to the example illustrated in FIG. 4. The data format of the product database 30 is not particularly limited as long as the product information is stored in a searchable state, and may be appropriately determined according to the embodiment. Further, the product information stored in the product database 30 may include information other than the information illustrated in FIG. 4. The product information may include, for example, information such as a description of the product, a product image, a price, and other attributes. These pieces of information may also be stored in the product data of the product database 30.

In the example of FIG. 4, in the site flag and the overseas flag, the fact that the flag is set is expressed by “1”, and the fact that the flag is not set is expressed by “0”. However, the expression format of the flag is not limited to such an example, and may be appropriately determined according to the embodiment. In addition, the expression of various kinds of information of each product is not limited to the example of FIG. 4, and may be appropriately determined according to the embodiment.

### User Database

FIG. 5 schematically illustrates an example of the user database 35 according to the present embodiment. In the example of FIG. 5, one record (row data) corresponds to user information of one user. The record shown in FIG. 5 includes fields for storing user ID (identity) and registered addresses.

In the user ID field, information for identifying the user (identifier, identification information) is stored. The registered address field stores an address that may be designated as a transportation destination of the product. Each record has one or more registered address fields. Each record may be configured to hold one or more addresses for a user. In the user database 35, the user information may be registered or updated at any timing including, for example, known timing such as creating or changing a user’s account.

Note that the data format of the user database 35 is not limited to the example illustrated in FIG. 5. The data format of the user database 35 is not particularly limited as long as the user information is stored in a searchable state, and may be appropriately determined according to the embodiment. The user information stored in the user database 35 may include information other than the information illustrated in FIG. 5. The user information may include, for example, information such as a password, payment information (e.g., credit number), and other user attributes. These pieces of information may also be stored in each record of the user database 35.

### 3 Operation Example

FIG. 6 is a flowchart illustrating an example of a processing procedure of the information processing device 1 according to the present embodiment. The processing procedure described below is an example of an information processing method according to an aspect of the present disclosure. However, the processing procedure described below is merely an example, and each step may be changed as much as possible. Further, the following processing procedures may be appropriately omitted, replaced, and added in accordance with the embodiment.

### S101 of Steps

In S101 of steps, the control unit 11 operates as the receiving unit 111. The control unit 11 receives the product search request 50 from the user terminal 2.

As a method of inputting the condition of the product search in the user terminal 2 and a method of transmitting the request 50 from the user terminal 2 to the information processing device 1, any method including a known method may be employed. In an example, the user terminal 2 may accept designation of a search condition via an input device. The search condition may be specified by, for example, a character string, a category, an attribute, or the like. The user terminal 2 may transmit the request 50 including the designated search condition to the information processing device 1 via the network using the communication interface. Upon receiving the request 50 from the user terminal 2, the control unit 11 advances the process to the following step S102.

### S102 of Steps

In S102 of steps, the control unit 11 operates as the search unit 112. The control unit 11 refers to the product database 30. The control unit 11 extracts the product information 55 of the product corresponding to the condition specified by the request 50 from the product database 30.

The extraction method (search method) of the product information 55 in the product database 30 may be appropriately determined in accordance with the data format or the like of the product database 30. As the extraction method, any method including a known method may be employed. In an example, when the product name is designated as the search condition, the control unit 11 refers to the value of the product name field and searches for product data in which the value corresponding to the designated condition is stored. Thus, the control unit 11 may extract the product information 55. As described above, in the product data, other information such as a description of the product, a price, and the like may be stored. The control unit 11 may extract the product information 55 based on the other information. When the control unit 11 extracts the product information 55 of the product corresponding to the request 50, the control unit 11 advances the process to the following step S103.

### S103 of Steps

In S103 of steps, the control unit 11 operates as the output unit 113. The control unit 11 returns the extracted product information 55 to the user terminal 2 so that the emission information can be output in association with the production site. In response to this, the user terminal 2 receives the product information 55 and outputs the received product information 55. In an example, the user terminal 2 includes an output device such as a display. The user terminal 2 outputs the product information 55 to the output device. However, the output destination of the product information 55 is not limited to such an example, and may be appropriately determined according to the embodiment.

As a method of returning the product information 55 to the user terminal 2, any method including a known method may be employed. In the present embodiment, the control unit 11 may transmit the product information 55 of the extracted product to the user terminal 2 via the network using the communication interface 13. In the user terminal 2, the product information 55 may be output in any format including, for example, a known format such as an image display or an audio output. The output method and the output form may be appropriately determined according to the embodiment.

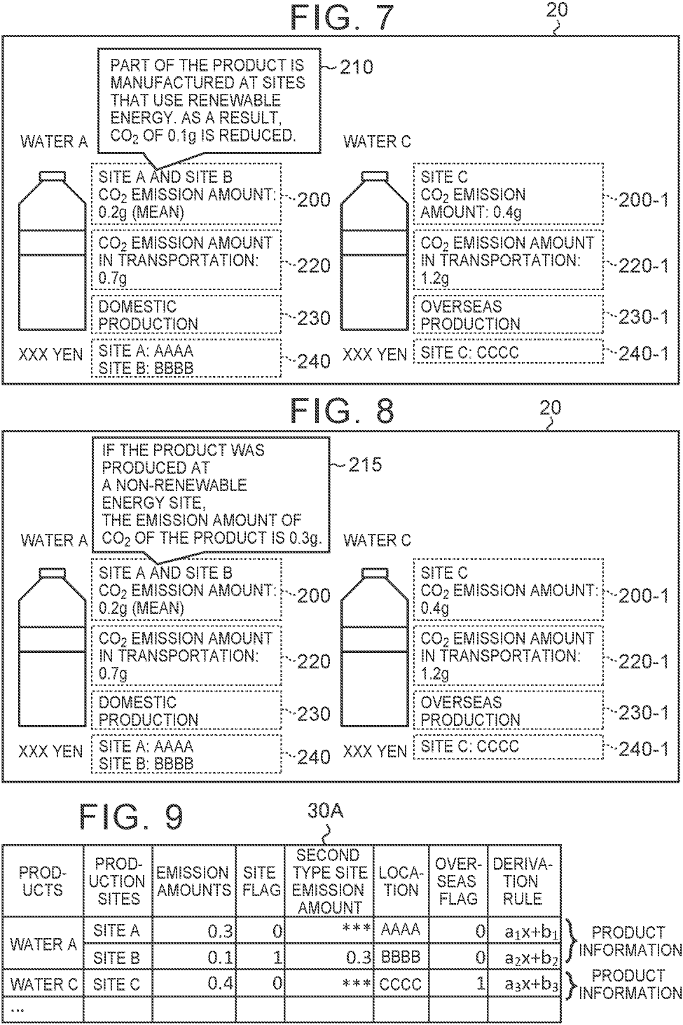

FIG. 7 schematically illustrates an example of an output form (screen display) of the product information 55 in the user terminal 2 according to the present embodiment. In the example of FIG. 7, it is assumed that the product information 55 of “water A” and “water C” in FIG. 4 is output to the output device 20 (display) of the user terminal 2 by screen display. The output-screen of the product information 55 may be generated by a known method such as Hyper Text Markup Language (HTML), Extensible Markup Language (XML).

In an example of this screen display, the value of the emission amount field is displayed in the region 200 in association with the value of the production site field. As a result, the emission amounts of greenhouse gas are output in association with the production sites. When a product (“water A”) is produced at a plurality of production sites, a statistical amount of the emission amount of the greenhouse gas at each production site may be output. In the example of FIG. 7, a simple average is adopted as an example of the statistical amount. When a product (“water C”) is produced at a single production site, the emission amount of greenhouse gas at a single production site may be output.

Note that, in a case where products are produced at a plurality of production sites, the statistical amount of the emission amount of the greenhouse gas at each production site may be calculated by the information processing device 1 or the user terminal 2 at the time of outputting the product information 55. Alternatively, the statistical amount may be calculated in advance, and the calculated statistical amount may be stored in the product database 30. In this case, by displaying the value of the corresponding field of the corresponding record, it is possible to output a statistical amount of the emission amount of greenhouse gas at each production site.

In the blow-out 210, the value of the reduction amount field of the product information 55 is displayed, so that the reduction amount of the emission of the greenhouse gas due to the production at the first type site is output. In the example of FIG. 7, since the production site that produces “water A” includes the first type site (“site B”), the balloon 210 corresponding to “water A” is displayed, and the reduction amount by the first type site is output.

In a case where the product is produced at a single first type site, the reduction amount by the first type site may be output as it is. On the other hand, in a case where the product is produced at a plurality of production sites, the statistical amount of the reduction amount may be output in the balloon 210 corresponding to the output of the statistical amount of the emission amount in the region 200. In the example of FIG. 7, a simple average is also adopted as an example of the statistical amount of the reduction amount corresponding to the display of the emission amount. However, the method of outputting the reduction amount in the case of being produced at a plurality of production sites is not limited to such an example. In another example, the reduction amount by the first type site may be output as it is. In a case where products are produced at a plurality of first type sites, the reduction amounts by the respective first type sites may be output individually. In still another example, in a case where a plurality of production sites for producing a product includes a plurality of first type sites, the statistical amount of the reduction amount of only the first type site may be output.

The output of the information in the region 200 and the balloon 210 is an example of the output of the comparison information. The output of information in region 200 and balloon 210 can visualize the contribution to reducing the emission amount of greenhouse gas by selecting products produced by production sites that utilize renewable energy. Note that the reduction amount may be expressed in another form such as, for example, the size of a forest that absorbs the reduced amount of carbon dioxide.

In region 220, the emission amount of greenhouse gases in transport are output. The emission amount in the transportation may be appropriately calculated from the information in the location field, the information in the derivation rule field, and the address specified by the user.

As an example, when the information processing device 1 calculates the emission amount of the greenhouse gas in the transportation, the control unit 11 may acquire the derivation rule from the derivation rule field in the product information 55 of the target product. The control unit 11 may acquire the location of the production site from the location field. In the following, for convenience of explanation, it is assumed that, as an example of the above derivation rule and FIG. 4, the derivation rule is defined so that the emission amount of greenhouse gas in transportation can be calculated according to the transportation distance.

The control unit 11 may acquire a user-specified address by an arbitrary method. In an example, the control unit 11 may acquire a user-specified address from the user terminal 2. In another example, the control unit 11 may acquire a user-specified address from the user database 35.

For example, the control unit 11 may request user authentication by login upon access from the user terminal 2. User authentication may be performed in any manner, including known ways. For example, the password may be further stored in the user database 35 in association with the identification information of the user, and the control unit 11 may authenticate the user by checking the password. In response to the user authentication, the control unit 11 may recognize the user of the user terminal 2 of the access source and acquire identification information of the user. The control unit 11 refers to the user database 35. The control unit 11 may extract the address information associated with the identification information from the user database 35 by collating the value of the user ID field with the acquired identification information. The control unit 11 may acquire a user-specified address from the extracted address information. In a case where a plurality of addresses are registered, the control unit 11 may receive, from the user terminal 2, a selection of an address to be a mailing destination from the plurality of registered addresses.

The control unit 11 searches for a transportation route from the location of the production site to the designated address on the map. The control unit 11 may acquire the transportation distance to the address specified by the user based on the search result. Then, the control unit 11 may derive the emission amount of the greenhouse gas in the transportation to the address designated by the user by substituting the acquired value of the transportation distance into the derivation rule and executing the arithmetic processing of the derivation rule. When the commodities are produced at a plurality of production sites, the control unit 11 may derive an emission amount of the greenhouse gas in transportation from each production site to an address designated by the user. In an example, the control unit 11 may transmit the derived emission amount to the user terminal 2 and output the derived statistical amount of the emission amount to the region 220. In another example, the control unit 11 may transmit the derived emission amount to the user terminal 2. In the region 220, the control unit 11 may individually output the emission amount of the greenhouse gas in the transportation for each production site.

Note that the computer that executes the process of deriving the emission amount according to the derivation rule is not limited to the information processing device 1. In another example, the control unit 11 may provide the value of the location field and the derivation rule field to the user terminal 2 as the product information 55. The control unit 11 may cause the user terminal 2 to execute a process of deriving an emission amount of the greenhouse gas in transportation. The output of information in region 220 is an example of outputting the emission amount of greenhouse gas in transport. The output of the region 220 allows visualization of the emission amount of greenhouse gas in the transport of goods from the production site to the user-specified address.

In the region 230, information corresponding to the overseas flag field is displayed, so that information indicating whether the location of the production site is domestic or overseas is output. The output of the information in the region 230 is an example of outputting information indicating whether the location of the production site is domestic or overseas.

In the example of FIG. 7, “domestic production” is displayed in the region 230 of “water A” in response to the value of the overseas flag field of “water A” being “0”. On the other hand, in the region 230 of “water C”, in response to the value of the overseas flag field of “water C” being “1”, “overseas production” is displayed. The information to be output to the region 230 may be specified based on the value of the location field instead of the value of the overseas flag field.

In the region 240, a part of the value of the location field is displayed, and thus an outline of the location of the production site is output. The output of information in the region 240 is an example of outputting an outline of the location of the production site. By including at least one of the region 230 and the region 240 in the screen display, it is possible to visualize the emission amount of the greenhouse gas in the transportation in association with the location of the production site.

FIG. 8 schematically illustrates another example of an output form (screen display) of the product information 55 in the user terminal 2 according to the present embodiment. In the example of FIG. 8, the balloon 210 that outputs the comparison information is replaced with a balloon 215 that employs a different output form. Except for this point, the screen shown in FIG. 8 is configured similarly to FIG. 7.

In the balloon 215, the emission amount of greenhouse gas of the target product in the case of production at the second type site is output. The emission amounts of greenhouse gases at the second type site may be calculated by adding the value of the reduction field to the value of the emission field. This calculation process may be executed by the information processing device 1 or may be executed by the user terminal 2.

Similar to the output mode of the reduction amount, in a case where the product is produced at a plurality of production sites, the statistical amount of the emission amount of the greenhouse gas at the second type site may be output at the balloon 215 corresponding to the output of the statistical amount of the emission amount in the region 200. When a part of the plurality of production sites is the first type site and the remainder is the second type site, the value of the emission amount field may be used as it is for the second type site. For the first type site, the virtual emission amount in the case of production at the second type site may be calculated by the above-described addition processing. Then, a statistical amount of the emission amount to be displayed on the balloon 215 may be calculated from the obtained value of the emission amount at each of the sites. However, the method of outputting the emission amount at the second type site in the case of being produced at a plurality of production sites is not limited to such an example. In another example, in a case where products are produced at a plurality of first type sites, the emission amounts at the second type sites calculated by the addition processing may be output individually.

On the other hand, in the region 200, the emission amount of greenhouse gas when at least a part of the product is produced at the first type site is output. The output of the information in the region 200 and the balloon 215 is another example of the output of the comparison information. The output of information in region 200 and balloon 215 can visualize the contribution to reducing the emission amount of greenhouse gas by selecting products produced by production sites that utilize renewable energy.

The output of the information illustrated in FIGS. 7 and 8 is an example of outputting the emission information in association with the production site. However, the output modes illustrated in FIGS. 7 and 8 are merely examples for convenience of explanation. The output form (screen design, order of audio output, and the like) of the product information 55 is not limited to such an example.

When the product information 55 includes the comparison information, the comparison information may be output by a user’s instruction (for example, the cursor is placed on the region 200 on the screen of FIG. 7 or FIG. 8) or may be output without depending on the user’s instruction. The same applies to other information. The form in which the comparison information is output is not limited to the balloon, and may be appropriately selected according to the embodiment. In an arbitrary area for outputting the product information 55, it may be displayed whether or not the target product is produced at a production site using renewable energy.

In addition, in FIG. 7 and FIG. 8, as an example of an output form of the location country information in the region 230, a character string indicating whether domestic production or overseas production is output is adopted. The output form of the location country information may not be limited to such an example. In another example, the location country information may be indicated by any sign. In yet another example, the location (address) of the production site may be output as the location country information in a state in which the country name in which the production site exists can be identified. In the region 240, the region 230 may be omitted when the outline of the location is output in a state in which the country name can be identified. The output of the information in the region 240 may also serve as the output of the location country information.

Further, in FIG. 7 and FIG. 8, as an example of an outline output form of the location in the region 240, only the prefectural name is output as an outline of the location when the production site is present in the country, and the country name and the prefectural name are output as an outline of the location when the production site is present overseas. However, the general output form of the location is not limited to such an example. The range to be displayed as an outline of the location may be appropriately determined according to the embodiment.

When the product information 55 is returned to the user terminal 2, the control unit 11 ends the processing procedure according to this operation example. Note that the control unit 11 may wait until receiving the request 50 from the user terminal 2 to execute the process of the step S101. Then, the control unit 11 may execute the process of step S102 and step S103 in response to receiving the request 50 from the user terminal 2. Accordingly, the control unit 11 may repeatedly execute the process of the step S103 from the step S101. That is, the information processing device 1 may be configured to continuously execute information processing for returning the product information 55 to the request 50 from the user.

### Features

The information processing device 1 according to the present embodiment can provide the product information 55 including the emission information indicating the emission amount of the greenhouse gases in association with the production site of the product by the process of the step S101 to the step S103. Accordingly, based on the information provided (FIG. 7 and FIG. 8 are examples thereof), the user can compare the emission amounts of the greenhouse gases between the production sites of the respective commodities. In this comparison, when the emission amount of greenhouse gas of the target product is smaller than that of other products of the same type, the user can specify that the production at the target production site is one of the factors for reducing the amount of greenhouse gas emissions of the target product. Therefore, according to this embodiment, it is possible to visualize at least a portion of the factors of the reduction of the emission amount of greenhouse gas by the choice behavior of products. As a result, it is possible to reduce the time and effort for the user to confirm the cause.

### 4 Modification

While embodiments of the present disclosure have been described in detail above, the foregoing description is merely illustrative of the present disclosure in all respects. Needless to say, various modifications and variations can be made without departing from the scope of the present disclosure. For example, the following changes are possible. In the following description, the same reference numerals are used for the same components as those in the above-described embodiment, and description of the same components as those in the above-described embodiment is omitted as appropriate. The following modifications can be combined as appropriate.

### 4.1

In the above embodiment, the emission amount of the greenhouse gas may be output for each component of the product. Further, in the above-described embodiment, when a product is produced at a plurality of production sites, one or more production sites (hereinafter, also referred to as “provider sites”) that provide the product to the user may be selected from among the plurality of production sites. The selection method may be arbitrarily determined. In one example, the source location may be designated by the user via the user terminal 2. In another example, any number of production sites close to a user-specified address (e.g., production sites closest to the specified address) may be selected from among a plurality of production sites. In this case, the emission amount of greenhouse gas of the product may be output for the selected one or more production sites.

### 4.2

In the above embodiment, the derivation rule is stored in the product database 30. However, the storage destination of the derivation rule is not limited to such an example. The derivation rule may be stored in a storage area different from the product database 30. Further, in the above-described embodiment, a derivation rule is set for each production site. However, the method of setting the derivation rule may not be limited to such an example. For example, a transportation route from each production site may be at least partially common, such as storing products produced at each of a plurality of production sites at a common storage location and providing the products to a user. In such a case, at least some of the derivation rules may be shared between production sites. That is, at least a part of the derivation rule may be set in common at a plurality of production sites.

### 4.3

In the above-described embodiment, the product database 30 and the user database 35 are stored in the storage device (the storage unit 12, the external storage device, the storage medium 91, and the like) of the information processing device 1. However, the storage destination of each database (30, 35) may not be limited to such an example. In another example, at least one of the product database 30 and the user database 35 may be stored in another computer such as a network server. The product database 30 and the user database 35 may be stored in different devices. When the product database 30 is stored in another computer, in the above-described step S102, the control unit 11 may access the product database 30 by connecting to another computer via a network or the like, and extract the product information 55 from the product database 30 (the product information 55 may be extracted to another computer). Similarly, when the user database 35 is stored in another computer, the control unit 11 may acquire user information including the registered address from the user database 35 by connecting to another computer via a network or the like.

### 4.4

In the example of FIG. 4 of the above-described embodiment, the comparison information includes information indicating the emission amount of greenhouse gas of the product and the amount of reduction in greenhouse gas emissions caused by the production of the product at the first type site. However, the configuration of the comparison information is not limited to such an example.

FIG. 9 schematically illustrates an example of a product database 30A according to the present modification. In the example of FIG. 9, the product data includes a second type site emission amount field instead of the reduction amount field of FIG. 4. Except for this point, the product database 30A according to the present modification may be configured similarly to the product database 30 according to the above-described embodiment.

In the second type site emission amount field, information indicating the amount of greenhouse gas emissions of products produced at the first type site, which would have occurred if the products were produced at the second type site, is stored. The information stored in the emission amount field and the second type site emission amount field is another example of the comparison information. That is, in the example of FIG. 9, the comparison information includes information indicating the emission amount of greenhouse gas of the product and the amount of greenhouse gas emissions of the product when the product is produced at the second type site.

In the above embodiment, the product database 30 may be replaced with the product database 30A according to the present modification. Similar to the above-described embodiment, the control unit 11 may receive the request 50 from the user terminal 2 by the step S101. In S102 of steps, the control unit 11 may extract the product information 55 of the product corresponding to the request 50 from the product database 30A. Then, the control unit 11 may return the extracted product information 55 to the user terminal 2 by the step S103.

In the user terminal 2, comparison information may be output as appropriate. In one example, comparison information may be output in the form of FIG. 8 by displaying the value of the second type site emission amount field. In another example, by subtracting the value of the emission amount field from the value of the second type site emission amount field, the amount of reduction in the emission of the greenhouse gas due to the production at the first type site may be calculated. This calculation process may be executed by the information processing device 1 or may be executed by the user terminal 2. Then, the comparison information may be output in the form of FIG. 7 by displaying the calculated value of the reduction amount. The case in which products are produced at a plurality of production sites may be the same as in the above-described embodiment.

According to this modification, it is possible to visualize the contribution to the reduction of the emission amount of the greenhouse gas by selecting the product produced by the production site using the renewable energy by the comparison information. Note that the configuration of the comparison information is not limited to the example of FIG. 4 (embodiment) and FIG. 9, and may be appropriately determined according to the embodiment. In another example, the comparison information may be configured to indicate an increase in greenhouse gas emissions when produced at a second type site, instead of a decrease in greenhouse gas emissions due to production at a first type site. The same applies to the output form.

### 4.5

In the above-described embodiment, it is not necessary to determine whether or not the production site uses renewable energy. In this case, components of the present disclosure relating to a production site utilizing renewable energy may be omitted.

In the above embodiment, the emission amount of the greenhouse gas in the transportation may not be output. In this case, the components of the present disclosure relating to outputting the emission amount of greenhouse gas in transportation may be omitted.

### 5 Supplement

The processing and units described in the present disclosure can be freely combined and implemented as long as there is no technical contradiction.

Further, the processes described as being executed by one device may be shared and executed by a plurality of devices. Alternatively, the processes described as being performed by different devices may be performed by a single device. In the computer system, the hardware configuration for implementing each function can be flexibly changed.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, HDD, etc.) and an optical disc (compact disc read-only memory (CD-ROM), digital versatile disc (DVD), Blu-ray disc, etc.), a ROM, a RAM, an EPROM, an electrically erasable programmable read only memory (EEPROM), a magnetic card, a flash memory, an optical card, and any type of medium suitable for storing electronic commands.

What is claimed is:

1. An information processing device comprising a control unit configured to:
receive a request for a product search from a user terminal;
extract product information of a product corresponding to the received request from a product database, the product information including emission information indicating an emission amount of greenhouse gas of the product in association with a production site of the product; and
return the extracted product information to the user terminal such that an output of the emission information in association with the production site is allowed.

2. The information processing device according to claim 1, wherein
when the production site of the product includes a first type site that utilizes renewable energy,
the emission information of the product includes comparison information indicating a difference between a first emission amount and a second emission amount, the first emission amount being an emission amount of the greenhouse gas of the product when the product is produced at the first type site, and the second emission amount being an emission amount of the greenhouse gas of the product when the product is produced at a second type site that does not utilize the renewable energy; and
the output of the emission information includes an output of the comparison information.

3. The information processing device according to claim 2, wherein the comparison information is composed of information indicating the emission amount of the greenhouse gas of the product and a reduction amount in an emission of the greenhouse gas achieved in a manner that the product is produced at the first type site rather than the second type site.

4. The information processing device according to claim 2, wherein the comparison information is composed of information indicating the emission amount of the greenhouse gas of the product and an emission amount of the greenhouse gas of the product when the product is produced at the second type site.

5. The information processing device according to claim 1, wherein:
the product information further includes information indicating a location of the production site; and
the output of the emission information in association with the production site includes an output of an emission amount of the greenhouse gas during transportation of the product from the production site to an address designated by a user, the emission amount of the greenhouse gas during the transportation of the product from the production site to the address designated by the user being derived in accordance with a derivation rule associated with the product.

6. The information processing device according to claim 5, wherein the output of the emission information in association with the production site further includes an output of information indicating whether the production site is located domestically or overseas.

7. The information processing device according to claim 5, wherein the output of the emission information in association with the production site further includes an output of an outline of a location of the production site.

8. The information processing device according to claim 1, wherein:
the output of the emission information in association with the production site
is composed of an output of the emission amount of the greenhouse gas of the product at a single production site when the product is produced at the single production site, and
is composed of an output of a statistical amount of the emission amount of the greenhouse gas of the product at each of a plurality of the production sites when the product is produced at the production sites.

9. An information processing method executed by a computer, the information processing method comprising:
receiving a request for a product search from a user terminal;
extracting product information of a product corresponding to the received request from a product database, the product information including emission information indicating an emission amount of greenhouse gas of the product in association with a production site of the product; and
returning the extracted product information to the user terminal such that an output of the emission information in association with the production site is allowed.

10. The information processing method according to claim 9, wherein
when the production site of the product includes a first type site that utilizes renewable energy,
the emission information of the product includes comparison information indicating a difference between a first emission amount and a second emission amount, the first emission amount being an emission amount of the greenhouse gas of the product when the product is produced at the first type site, and the second emission amount being an emission amount of the greenhouse gas of the product when the product is produced at a second type site that does not utilize the renewable energy; and
the output of the emission information includes an output of the comparison information.

11. The information processing method according to claim 10, wherein the comparison information is composed of information indicating the emission amount of the greenhouse gas of the product and a reduction amount in an emission of the greenhouse gas achieved in a manner that the product is produced at the first type site rather than the second type site.

12. The information processing method according to claim 10, wherein the comparison information is composed of information indicating the emission amount of the greenhouse gas of the product and an emission amount of the greenhouse gas of the product when the product is produced at the second type site.

13. The information processing method according to claim 9, wherein:
the product information further includes information indicating a location of the production site; and
the output of the emission information in association with the production site includes an output of an emission amount of the greenhouse gas during transportation of the product from the production site to an address designated by a user, the emission amount of the greenhouse gas during the transportation of the product from the production site to the address designated by the user being derived in accordance with a derivation rule in association with the product.

14. The information processing method according to claim 13, wherein the output of the emission information in association with the production site further includes an output of information indicating whether the production site is located domestically or overseas.

15. The information processing method according to claim 13, wherein the output of the emission information in association with the production site further includes an output of an outline of a location of the production site.

16. The information processing method according to claim 9, wherein
the output of the emission information in association with the production site
is composed of an output of the emission amount of the greenhouse gas of the product at a single production site when the product is produced at the single production site, and
is composed of an output of a statistical amount of the emission amount of the greenhouse gas of the product at each of a plurality of the production sites when the product is produced at the production sites.

17. A non-transitory storage medium storing a program for causing a computer to execute an information processing method, the information processing method comprising:
receiving a request for a product search from a user terminal;
extracting product information of a product corresponding to the received request from a product database, the product information including emission information indicating an emission amount of greenhouse gas of the product in association with a production site of the product; and
returning the extracted product information to the user terminal such that an output of the emission information in association with the production site is allowed.

18. The storage medium according to claim 17, wherein
when the production site of the product includes a first type site that utilizes renewable energy,
the emission information of the product includes comparison information indicating a difference between a first emission amount and a second emission amount, the first emission amount being an emission amount of the greenhouse gas of the product when the product is produced at the first type site, and the second emission amount being an emission amount of the greenhouse gas of the product when the product is produced at a second type site that does not utilize the renewable energy; and
the output of the emission information includes an output of the comparison information.

19. The storage medium according to claim 17, wherein:
the product information further includes information indicating a location of the production site; and
the output of the emission information in association with the production site includes an output of an emission amount of the greenhouse gas during transportation of the product from the production site to an address designated by a user, the emission amount of the greenhouse gas during the transportation of the product from the production site to the address designated by the user being derived in accordance with a derivation rule in association with the product.

20. The storage medium according to claim 17, wherein
the output of the emission information in association with the production site
is composed of an output of the emission amount of the greenhouse gas of the product at a single production site when the product is produced at the single production site, and
is composed of an output of a statistical amount of the emission amount of the greenhouse gas of the product at each of a plurality of the production sites when the product is produced at the production sites.
